(19) United States
(12) Patent Application Publication
(10) Pub. No.: US 2016/0059508 A1
(43) Pub. Date: Mar. 3, 2016

(54) TOOL FOR PRODUCING FOLD LINES

(71) Applicant: VOESTALPINE PRECISION STRIP GMBH, Boehlerwerk (AT)

(72) Inventor: Joshua JONES, Sewickley, PA (US)

(73) Assignee: VOESTALPINE PRECISION STRIP GMBH, Boehlerwerk (AT)

(21) Appl. No.: 14/840,472

(22) Filed: Aug. 31, 2015

(30) Foreign Application Priority Data
Sep. 1, 2014 (AT) A50602/2014

(51) Int. Cl. B31F 1/08; B26D 3/08

(52) U.S. Cl. CPC B31F 1/08; B26D 3/085

(57) ABSTRACT

The invention relates to a tool for producing folding lines in flat materials which is composed of a metallic band-shaped base body with a working section and a supporting section with a supporting edge. To create a tool which forms grooved regions and scored regions between the grooved regions, in which scored regions the tool possibly only penetrates the flat material at isolated points, it is provided according to the invention that the working section is composed of grooving regions with a profile that is rounded in cross-section and of scoring regions with flank surfaces forming in cross-section from blades that start from a tip and extend to a base and are sharp-edged on both sides, wherein the outermost rounded profile surface of the grooving regions and the tips of the scoring regions have the same distance from the opposing supporting edge of the tool.

### CROSS-REFERENCE TO RELATED APPLICATIONS

The present application claims priority under 35 U.S.C. §119 of Austrian Patent Application No. A 50602/2014 filed Sep. 1, 2014, the disclosure of which is expressly incorporated by reference herein in its entirety.

### BACKGROUND OF THE EMBODIMENTS

1. Field of the Embodiments

The invention relates to a tool for producing fold lines in flat materials, such as cardboard, corrugated cardboard, honeycomb packaging, plastic surfaces and the like, composed of a metallic band-shaped base body with a working section arranged on a longitudinal edge of the same and of a uniformly spaced opposing supporting section with a supporting edge.

2. Discussion of Background Information

For dimensionally accurate and visually congruent edges of folded objects, a working of flat material by the tools described above, referred to as grooving lines, is usually necessary.

The aim is thereby to reduce, during the working of cardboard, corrugated cardboard or plastic film as the case may be, the bending resistance of the material along predefined lines to such an extent that at these positions, a subsequent folding is possible without problems and clean lines or folds are produced. For example, during a working of corrugated cardboard, regardless of whether this working takes place in a flatbed process or a rotation process, this is typically achieved by pressing the corrugated medium flat by grooving lines. Grooves in the direction of the corrugation, or at a slight angle thereto, are thereby consistently problematic with regard to a formation of the edges.

Through an alternating grooving and cutting via a combination line, an additional weakening of the material can be achieved at the bend lines, so that the orientation of the corrugation has little influence on the quality of the scoring or folding.

Particularly, in the rotation process, combination lines alternatingly comprise serrated cutting sections and smooth grooving sections. The cutting or serrated sections project significantly past the height of the grooving section. The disadvantage thereby is that, in the bending line, the corrugated cardboard paper positioned on the outside on the finished product is cut through in some sections. Both the imperviousness of the end product and also the visual quality of the end product suffer therefrom.

### SUMMARY OF THE EMBODIMENTS

Embodiments of the invention are directed to a tool for producing folding lines of the type named at the outset, which creates, during a working of flat material, grooved regions and cut or scored regions therebetween. In these regions, a penetration by the tool through the cover sheet or laminating sheet of the flat material, in particular of the corrugated cardboard, occurs possibly only at isolated points.

Accordingly, the tool according to embodiments has a working section composed of grooving regions with a profile that is rounded in cross-section or that achieves a non-severing pressing-flat of the flat material, and of scoring regions with flank surfaces forming blades or cutting edges that start from a tip and extend to the base and in cross-section are sharp-edged on both sides. The outermost rounded profile surface of the grooving regions and the tips of the scoring regions have a same distance from the opposing supporting edge.

Advantages achieved by embodiments can be seen in that the subsequently visible outside of the edge of the flat material does not exhibit any punctures or only does so to a minimal extent.

Embodiments of the invention are directed to a tool for producing folding lines in flat materials. The tool includes a metallic band-shaped base body having a longitudinal edge with a working section arranged thereon and a uniformly spaced opposing supporting section with a supporting edge. The working section has: grooving regions with a profile that is structured with a rounded cross-section or that is structured to achieve a non-severing pressing-flat of the flat material, and scoring regions with flank surfaces forming cutting edges that extend from a base to a tip and that, in cross-section, are sharp-edged on both sides. An outermost point of the grooving regions and the tips of the scoring regions have the same distance from the supporting edge.

According to embodiments, at least one of: each of the grooving regions can have a same longitudinal extension and each of the scoring regions can have a same longitudinal extension.

In accordance with other embodiments, in the scoring region, the cutting edges can be arranged at an angle α of between 30° to 105° with respect to one another.

According to other embodiments, in cross-section, the sharp-edged cutting edges may have an angle β of between 20° to 60° at the tip.

Further, in cross-section, the tip of each cutting edge may include a rounding of 0.01 mm to 0.1 mm.

According to still other embodiments, the supporting edge and at least one of the surfaces and edges of the working region can be worked and may have a material hardness of between 500-700 HV in a surface region up to a depth of between 0.15 mm to 0.4 mm.

In other embodiments, the grooving regions may have in cross-section a different thickness than that of the base body.

In still other embodiments, the flat materials can include cardboard, corrugated cardboard, honeycomb packaging, plastic.

Embodiments are directed to a method of forming a tool for producing folding lines in flat materials. The method includes forming a metallic band-shaped base body having a longitudinal edge with a working section arranged thereon and a supporting edge uniformly spaced from the longitudinal edge, and working the working section to form: at least one groove region with a profile that is structured with a rounded cross-section or that is structured to achieve a non-severing pressing-flat of the flat material, and at least one scoring region with flank surfaces forming cutting edges that extend from a base to a tip and that, in cross-section, are sharp-edged on both sides. An outermost point of the grooving regions and the tips of the scoring regions have the same distance from the supporting edge.

According to embodiments, the cutting region can be worked into the working section between two scoring regions.

In accordance with other embodiments, the scoring region can be worked into the working section between two cutting regions.

In embodiments, the working of the scoring region may include removing of material from the working section.

According to further embodiments, at least one of: the at least one cutting region comprises a plurality of cutting regions having a same longitudinal extension; and the at least one scoring region comprises a plurality of scoring regions having a same longitudinal extension.

In other embodiments, in the scoring region, the cutting edges in a direction of the longitudinal edge can be worked into the working section at an angle α of between 30° to 105° to one another.

According to still other embodiments, in cross-section, the sharp-edged cutting edges can be worked into the working section at an angle β of between 20° to 60° at the tip.

In accordance with still yet other embodiments of the present invention, the working of the profile of the groove region and of the edges of the scoring region can result in a material hardness of between 500-700 HV in a surface region up to a depth of between 0.15 mm to 0.4 mm.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a tool in a front view; and

FIG. 2 shows a cross-sectional view of the depicted in FIG. 1 along section A-A.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

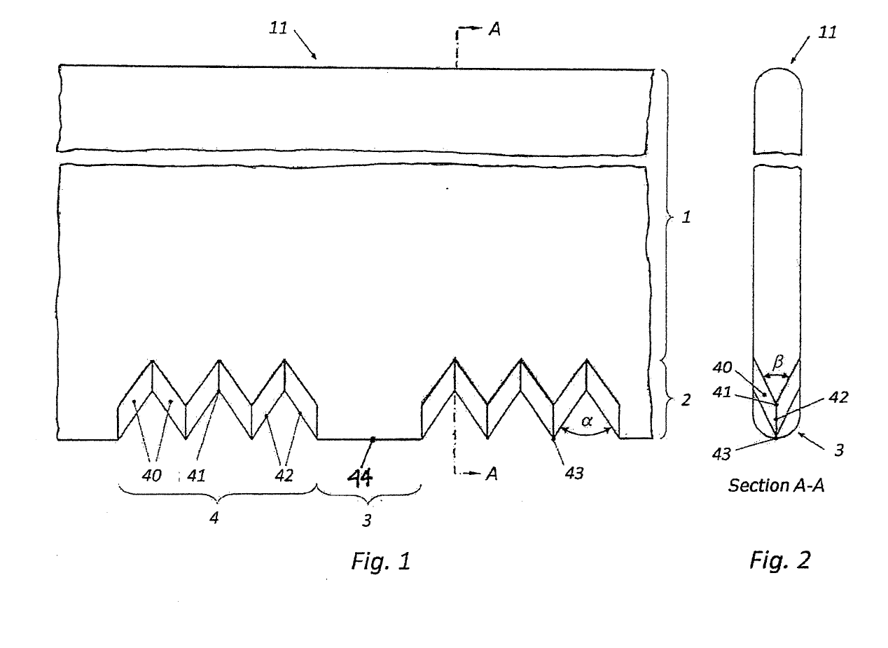

The tool schematically illustrated in FIGS. 1 and 2 shows an exemplary embodiment of the invention that includes, and preferably is essentially composed of, a base body 1 with a supporting edge 11 and a working section 2. For producing the tool, a band-shaped starting material is often used in which the supporting edge 11 and the grooving region 3, or a surface thereof, are requisitely spaced.

Scoring regions 4 are worked into the grooving region 3 in an alternating manner, and possibly by a material removal, while opposing flank surfaces 40 are formed. The sharp-edged tips 43 and the front face 44 in the grooving region 3 have essentially a same distance to the supporting edge 11 of the tool.

Depending on the production or material of the flat material, in particular, depending on the different mechanical properties thereof, if, e.g., recycled materials are used, it can be advantageous that the thickness of the grooving regions 3 of the tool is embodied or formed differently compared to that of the base body 1.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

TABLE OF REFERENCE NUMERALS:

```
  1: base body
  2: working section
  3: grooving region
  4: scoring region
40: flank surfaces
41: base of the blades
42: cutting edges
43: tips of the scoring regions
44. front face of grooving region
11: supporting edge
```

What is claimed:

1. A tool for producing folding lines in flat materials, comprising:
a metallic band-shaped base body having a longitudinal edge with a working section arranged thereon;
a uniformly spaced opposing supporting section with a supporting edge,
wherein the working section has:
grooving regions with a profile that is structured with a rounded cross-section or that is structured to achieve a non-severing pressing-flat of the flat material, and
scoring regions with flank surfaces forming cutting edges that extend from a base to a tip and that, in cross-section, are sharp-edged on both sides,
wherein an outermost point of the grooving regions and the tips of the scoring regions have the same distance from the supporting edge.

2. The tool according to claim 1, wherein at least one of:
each of the grooving regions have a same longitudinal extension and
each of the scoring regions have a same longitudinal extension.

3. The tool according to claim 1, wherein, in the scoring region, the cutting edges are arranged at an angle α of between 30° to 105° with respect to one another.

4. The tool according to claim 1, wherein, in cross-section, the sharp-edged cutting edges have an angle β of between 20° to 60° at the tip.

5. The tool according to claim 1, wherein, in cross-section, the tip of each cutting edge comprises a rounding of 0.01 mm to 0.1 mm.

6. The tool according to claim 1, wherein the supporting edge and at least one of the surfaces and edges of the working region are worked and have a material hardness of between 500-700 HV in a surface region up to a depth of between 0.15 mm to 0.4 mm.

7. The tool according to claim 1, wherein the grooving regions have in cross-section a different thickness than that of the base body.

8. The tool according to claim 1, wherein the flat materials include cardboard, corrugated cardboard, honeycomb packaging, plastic.

9. A method of forming a tool for producing folding lines in flat materials, comprising:
forming a metallic band-shaped base body having a longitudinal edge with a working section arranged thereon and a supporting edge uniformly spaced from the longitudinal edge; and
working the working section to form:
at least one groove region with a profile that is structured with a rounded cross-section or that is structured to achieve a non-severing pressing-flat of the flat material, and
at least one scoring region with flank surfaces forming cutting edges that extend from a base to a tip and that, in cross-section, are sharp-edged on both sides,
wherein an outermost point of the grooving regions and the tips of the scoring regions have the same distance from the supporting edge.

10. The method according to claim 9, wherein the cutting region is worked into the working section between two scoring regions.

11. The method according to claim 9, wherein the scoring region is worked into the working section between two cutting regions.

12. The method according to claim 9, wherein the working of the scoring region comprises removing of material from the working section.

13. The method according to claim 9, wherein at least one of:
the at least one cutting region comprises a plurality of cutting regions having a same longitudinal extension; and
the at least one scoring region comprises a plurality of scoring regions having a same longitudinal extension.

14. The method according to claim 9, wherein, in the scoring region, the cutting edges in a direction of the longitudinal edge are worked into the working section at an angle α of between 30° to 105° to one another.

15. The method according to claim 9, wherein, in cross-section, the sharp-edged cutting edges are worked into the working section at an angle β of between 20° to 60° at the tip.

16. The method according to claim 9, wherein the working of the profile of the groove region and of the edges of the scoring region results in a material hardness of between 500-700 HV in a surface region up to a depth of between 0.15 mm to 0.4 mm.
